(19) United States
(12) Patent Application Publication
(10) Pub. No.: US 2012/0099839 A1
(43) Pub. Date: Apr. 26, 2012

(54) ENTRY POINT REGISTERING METHOD AND RECORDING AND REPRODUCING APPARATUS USING THE SAME

(76) Inventor: Shinichi KIKUCHI, Kawasaki-shi (JP)

(21) Appl. No.: 13/341,046

(22) Filed: Dec. 30, 2011

Related U.S. Application Data
(63) Continuation of application No. 11/683,057, filed on Mar. 7, 2007, now abandoned.

(30) Foreign Application Priority Data
Mar. 31, 2006 (JP) 2006-100547

(51) Int. Cl. H04N 9/80

(52) U.S. Cl. 386/241; 386/E09.011

(57) ABSTRACT

According to one embodiment, an information storage medium having an area in which ESOB type A/ESOB type B is recorded and an area in which HDVR_MG (or VMG) for managing ESOB type A/ESOB type B is recorded is used. HDVR_MG includes identification data (SFI_ID/C_TY) for determining whether an object to be managed is of ESOB type A or ESOB type B. HDVR_MG is read from the information storage medium. If the contents of identification data (SFI_ID/C_TY) indicate ESOB type A, entry points are registered at a specific reproducing time (at intervals of L minutes). If the contents of identification data (SFI_ID/C_TY) indicate ESOB type B, entry points are registered at a specific packet arrival time (at intervals of L minutes).

### CROSS-REFERENCE TO RELATED APPLICATIONS

This application is a continuation of and claims the benefit of priority under 35 U.S.C. §120 from U.S. Ser. No. 11/683,057 filed Mar. 7, 2007, and claims the benefit of priority under 35 U.S.C. §119 from Japanese Patent Application No. 2006-100547 filed Mar. 31, 2006, the entire contents of each of which are incorporated herein by reference.

### BACKGROUND

1. Field

One embodiment of the invention relates to an entry point registering method used in an apparatus for recording and reproducing a digital stream signal in digital TV broadcasting or the like.

2. Description of the Related Art

In recent years, TV broadcasting has moved into the age of digital broadcasting whose main broadcast content is Hi-Vision programming (high-definition audio-visual programs). In satellite digital TV broadcasting and terrestrial digital TV broadcasting now in operation, MPEG-2 transport streams (hereinafter, abbreviated as MPEG-TS as needed) are used. In the field of digital broadcasting that uses moving images, it is conceivable that MPEG-TS will still be used on the standard scale in the future. With the start of such digital TV broadcasting, there has been an increasing market need for streamers that enable digital TV broadcast content to be recorded directly (onto hard disk and/or optical disk).

As an example of streamers using an optical disk, such as DVD-RAM, a recording and reproducing apparatus has been disclosed in Jpn. Pat. Appln. KOKAI Publication No. 2002-84479. As an example of placing entry points in a digitally recorded object (a video object obtained by encoding an analog signal AV signal into MPEG2-PS), a digital video information medium, a digital video information recording and reproducing apparatus, and a digital video information processing method has been disclosed in Jpn. Pat. Appin. KOKAI Publication No. 2000-322875.

In a stream object in which digital broadcasts (MPEG-TS) have been recorded, there can be a type managed on the basis of reproducing time and a type managed on the basis of packet arrival time. Conventional techniques for placing entry points in such a stream object (in a manner suitable to the type) have not been found.

An object of the invention is to place entry points in stream objects that might differ in type.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B, 1C, 1D, 1E, 1F, 1G, and 1H are diagrams to help explain a data structure acc first embodiment of the invention;

FIG. 2 is a diagram to help explain the relationship between a reproduction management information layer, an object management information layer, and an object layer in the data structure of the first embodiment;

FIG. 3 is a diagram to help explain a file structure according to the first embodiment;

FIG. 4 is a diagram to help explain the way stream file information (ESTR_FIT) and PGC information (EX_ORG_PGCI, EX_UD_PGCIT) included in a VMG file (HDVR-MG) are configured;

FIG. 5 is a diagram to help explain a concrete example of EX_CI;

FIG. 6 is a diagram to help explain a concrete example of C_EPI;

FIG. 7 is a block diagram showing an apparatus which records and reproduces AV information (such as digital TV broadcast programs) into and from an information recording medium (such as an optical disk or a hard disk) using the data structure of the first embodiment;

FIG. 8 is a flowchart to help explain an example of the operation of the entire apparatus;

FIG. 9 is a flowchart to help explain an editing process (ST28);

FIG. 10 is a flowchart to help explain an example of the entire reproducing operation;

FIG. 11 is a flowchart to help explain an EVOB reproducing operation;

FIG. 12 is a flowchart to help explain an ESOB reproducing operation;

FIG. 13 is a flowchart to help explain an AT_SOB reproducing operation;

FIG. 14 is a flowchart to help explain an example of the process of reproducing a cell;

FIG. 15 is a flowchart to help explain an entry point menu displaying process;

FIG. 16 is a diagram to help explain an example of title menu display with entry points;

FIGS. 17A, 17B, and 17C are diagrams to help explain a method of placing entry points (in the case of type A);

FIG. 18 is a diagram to help explain another method of placing entry points (in the case of type B);

FIG. 19 is a flowchart to help explain an entry point automatic generating process; and

FIG. 20 is a diagram to help explain the way stream file information (ESTR_FIT) is configured.

### DETAILED DESCRIPTION

Various embodiments according to the invention will be described hereinafter with reference to the accompanying drawings. In general, according to one embodiment of the invention, in a method of using an information storage medium including a stream object recording area in which at least one of a type A stream object to be recorded in a type A recording mode for management using a reproducing time and a type B stream object to be recorded in a type B recording mode for management using a packet arrival time is recorded using packets and a management information recording area in which management information for managing the recording contents of the stream object recording area is recorded, and registering entry points in the recording contents of the stream object recording area, the management information being composed of stream file information and program chain information, the stream file information including first identification data for determining whether an object to be managed is in the type A recording mode or the type B recording mode, and/or the program chain information including second identification data for determining whether a cell serving as a reproducing unit in the recording contents of the stream object recording area is in the type A recording mode or the type B recording mode, an entry point registering method comprises reading the management information from the information storage medium, when the contents of the first identification data and/or second identification data included in the management information indicate the type A recording mode, registering entry points at a specific reproducing time and when the contents of the first identification data and/or second identification data included in the management information indicate the type B recording mode, registering entry points at a specific packet arrival time.

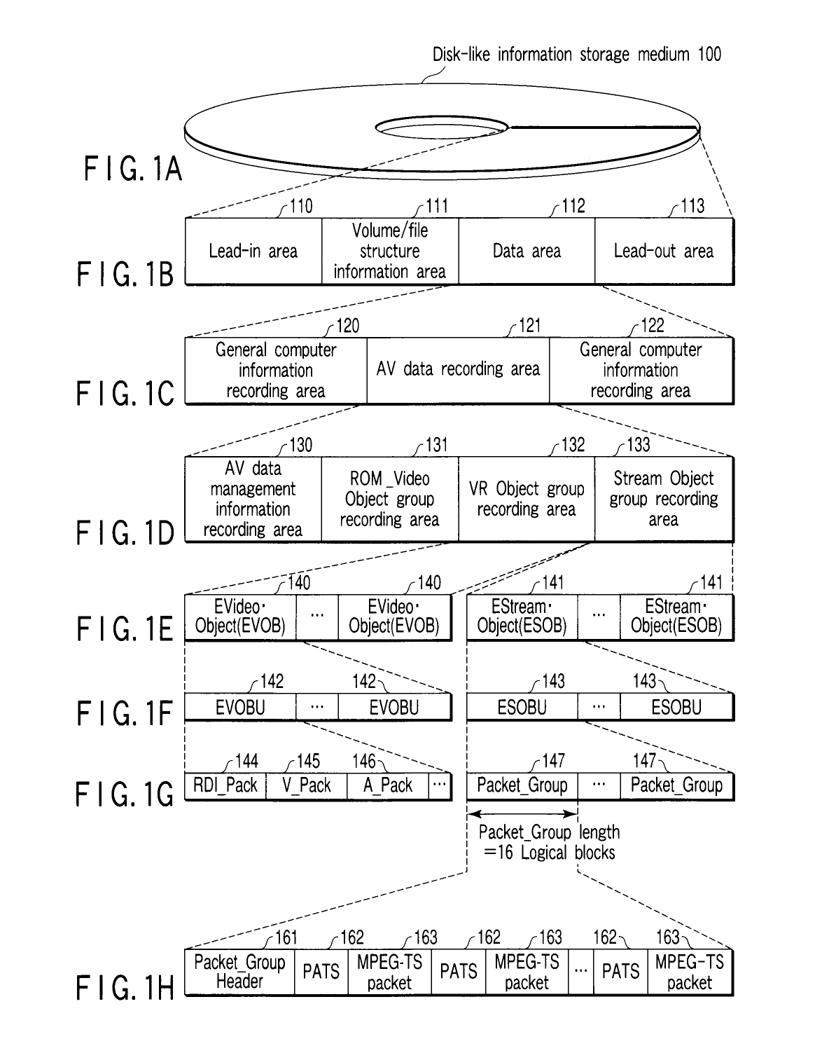

Hereinafter, referring to the accompanying drawings, embodiments of the invention will be explained. FIGS. 1A, 1B, 1C, 1D, 1E, 1F, 1G, and 1H are diagrams to help explain a data structure according to an embodiment of the invention. A typical recordable or rewritable information recording medium is a DVD disk (e.g., DVDR, DVDRW, or DVD-RAM with a single recording layer or a plurality of recording layers using a red layer with a wavelength of about 650 nm or a blue-violet to blue laser with a wavelength of 405 nm or less). As shown in FIG. 1A, the disk 100 includes a volume/file structure information area 111 in which a file system is stored and a data area 112 in which data files are actually recorded. The file system is composed of information that indicates where which file has been recorded.

The data area 112 includes areas 120, 122 in which a general computer records data and an area 121 in which AV data is recorded. The AV data recording area 121 includes an AV data management information area 130 in which a video manager (VMG) file for managing AV data exists, a ROM_Video object group recording area 131 in which a file of object data conforming to the DVD-Video (ROM Video) standard is recorded, a VR object group recording area 132 in which a file (VRO file) of object data (EVOBS: Extended Video Object Set) conforming to the video recording (VR) standard is recorded, and a recording area 133 in which a stream object data (ESOBS: Extended Stream Object Set) file (SRO file) having objects compatible with digital broadcasting written in it is recorded. A recording standard for SRO files is referred to as a stream recording (SR) standard as needed.

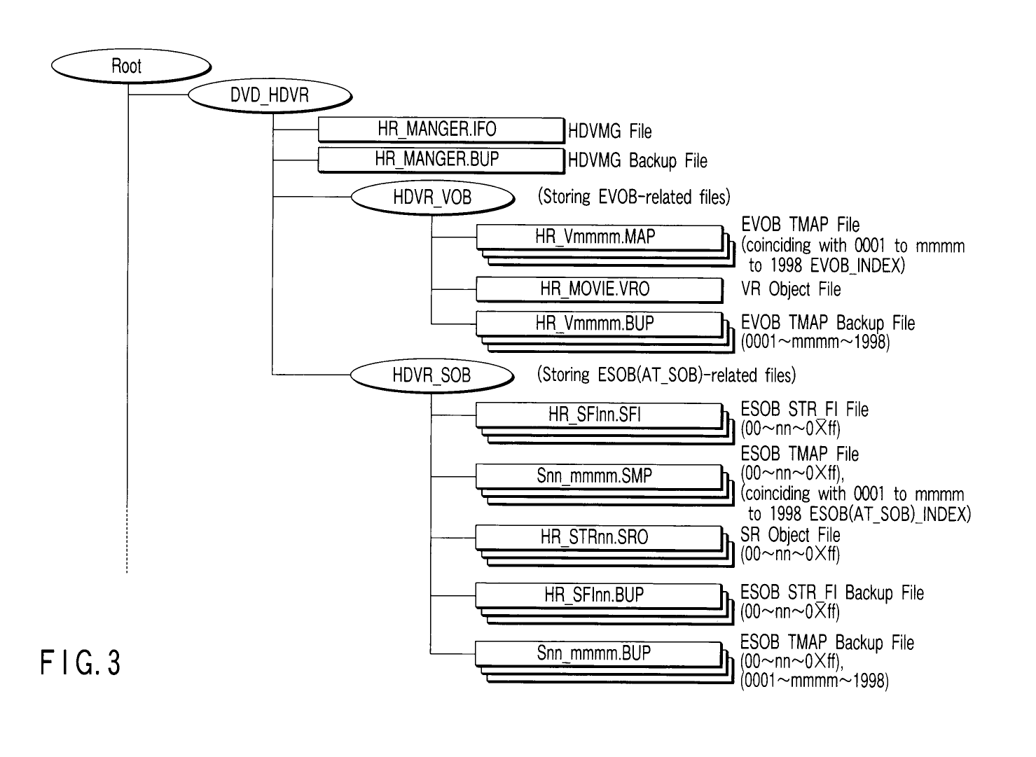

DVD-Video (ROM Video) is divided into file directories on a format basis in such a manner that a video title set (VIDEO-TS) and recording-reproducing DVD (DVD-RTR) are grouped into DVD-RTAV. A file of a new DVD standard compatible with digital broadcasting explained in the embodiment is stored in, for example, a directory DVD_HDVR (described later with reference to FIG. 3). In the directory DVD_HDVR, a VMG file for managing data, an object file VRO for recording analog, such as analog broadcasts or line input, and an SRO file serving as a digital broadcast object are recorded. The SRO file makes ESOBS.

In the configuration of FIG. 1G, an ESOBU 143 is composed of one or more Packet Groups 147. Each Packet Group 147 corresponds to, for example, 16 (or 32) packs (1 pack=1 Logical Block: 2048 bytes). Each Packet Group 147 is composed of a Packet Group Header 161 and a plurality of TS packets 163 (for example, 170 TS packets). The arrival time of each TS packet can be expressed by PATS (Packet Arrival Time Stamp: 4 bytes) 162 placed in front of each TS packet. The Packet Group Header 161 placed at the head of the Packet Group 147 is composed of Header_ID (0x00000FA5) (not shown), packet group general information PKT_GRP_GI, copy management information CCI (Copy Control Information) or CPI (Content Protection Information), and manufacturer information MNI or MNFI in that order.

To measure the arrival time of a TS packet, the recording start has to be set to 0 (or a specific value) and the value has to be counted up linearly until the recording has been completed. STC (System Time Counter) and PATS do not always have the same value (because of a difference in the initial value). However, while being in synchronization with reproduction, the count interval of the PATS counter has to be synchronized with the count interval of the STC counter corresponding to the interval between an intake of PCR (Program Clock Reference) and the next intake of PCR. PCR is included in an adaptation field (not shown) in MPEG-TS. Up to two ESOBs are allowed to be mixed in a Packet Group. This means that Packet Groups need not be aligned on an ESOB basis.

Low 4 bytes unique to each PATS are included in each PATS (packet arrival time information field). High 2 bytes of the begin PATS are designed to be included in FIRST_PATS_EXT written in packet group general information (PKT_GRP_GI) (not shown) in Packet Group Header 161. This enables the amount of data to be decreased more than when 6-byte packet arrival time is written separately into each PATS.

Although not shown, PKT_GRP_GI is composed of packet type PKT_GRP_TY (1=MPEG-TS), Packet Group version number VERSION, Packet Group status information PKT_GRP_SS, the number of valid packets in Packet Group Valid_PKT_Ns, and high 2 bytes of PART for the begin packet FIRST_PATS_EXT.

Moreover, PKT_GRP_SS is composed of bit STUF indicating whether stuffing has been done (when the STUF bit is set, this means that Valid_PKT_Ns takes a value other than 0xAA) and PATS_SS. PATS_SS is a value representing the accuracy of PATS (for example, if PATS_SS is 00, both PATS and FIRST_PATS_EXT are valid and have a 6-byte accuracy; if PATS_SS is 01, only PATS is valid and has a 4-byte accuracy; and if PATS_SS is 10, neither PATS nor FIRST_PATS_EXT is valid and have no accuracy).

An extended byte FIRST_PATS_EXT in PATS in the begin packet is composed of, for example, high 2 bytes of the arrival time of the packet at the beginning of Packet Group. Low 4 bytes of the arrival time are provided ahead of each packet. This makes it possible to reproduce a more accurate time.

In Packet Group Header 161, there is a description area for CP_CTL_INFO (not shown) (copy control information: abbreviated as CCI or CPI as needed). CP_CTL_INFO is in CCI (or CPI) of Packet Group Header 161. Copy control of each Packet Group is performed at Packet Group Header 161. The value of CCI (or CPI) is set using a digital copy control descriptor or content use descriptor. Its contents are: for example, CGMS (0=inhibit, 1=unconditional permission), APS (0=no APS, 1=APS type 1 added, 2=APS type 2 added, 3=APS type 3 added), EPN (0=content protection (Internet output protection), 1=no content protection), and ICT (0=resolution limit, 1=unlimited).

Alternatively, CCI (or CPI) is composed of digital copy control (00=copy inhibit, 01=one-copy permission, 11=copy inhibit), analog copy control (00=no APS, 01=APS type 1, 10=APS type 2, 11=APS type 3), EPN (0=content protection, 1=no content protection), and ICT (0=analog video output resolution limit, 1=unlimited). Here, APS stands for Analog Protection System. In this embodiment, Macrovision (registered trademark) is assumed.

It is conceivable that copy control information (CCI or CPI) is placed on the management information side (ESOBI_GI) to perform copy management (copyright management) on the whole or that CCI (or CPI) is placed on both the management information side and object side (Packet Group) and priority is given to the object side (Packet Group) and copy management (copyright management) is performed in two stages, management information and objects. Specifically, on the title menu, using CCI in ESOBI_GI, processing can be done, giving priority to Packet Group in an actual operation of the apparatus.

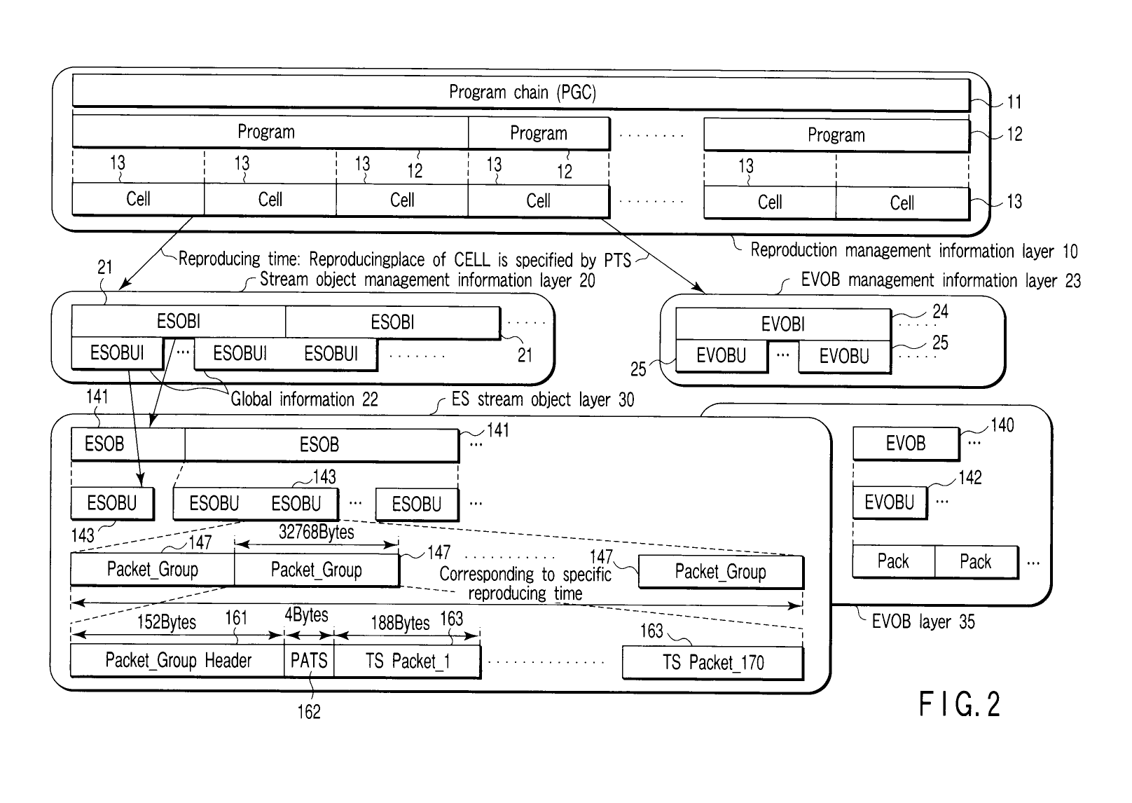

FIG. 2 is a diagram to help explain the relationship between a reproduction management information layer, an object management information layer, and an object layer in the data structure of the embodiment. As shown in FIG. 2, SR management data is recorded in a file common to VR. SR and VR share control and SR and VR are linked with each other on a cell basis. A reproducing place is specified in units of reproducing time. The management data is referred to as HR_MANGER.IFO (explained later with reference to FIG. 3).

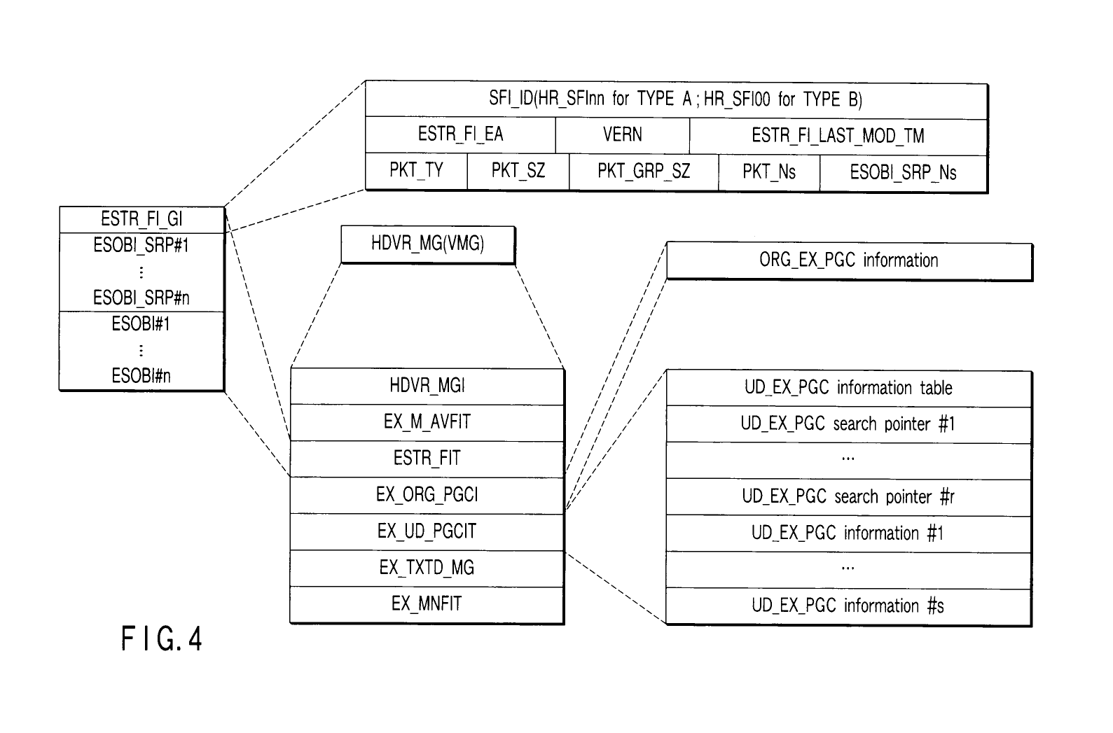

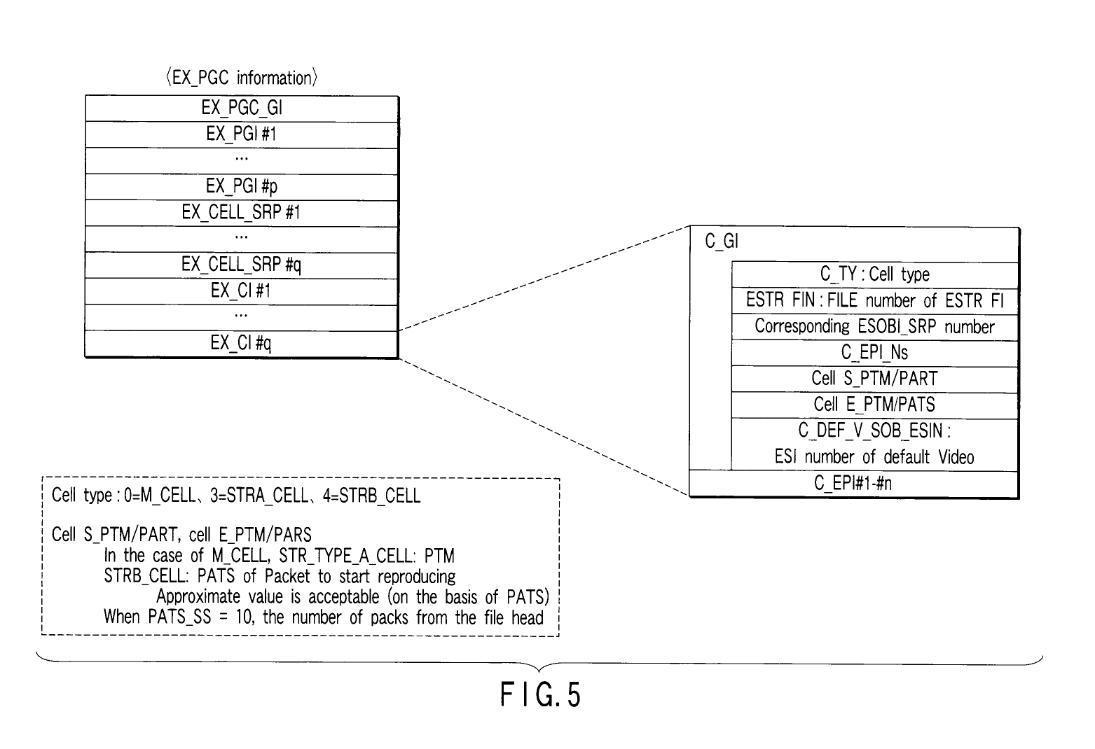

ESOBS is composed of one or more ESOBs 141. Each ESOB corresponds to, for example, one program in TV broadcasting. ESOB is composed of one or more ESOBUs (Extended Stream object units). ESOBU corresponds to object data for a specific time interval (varying according to the value of ESOBU_PBTM_RNG [not shown]) or one or more items of GOP data. (ESOBU_PB_TM_RNG is included in time map information ESOB_TMAPI (not shown) in ESOBI of FIG. 4).

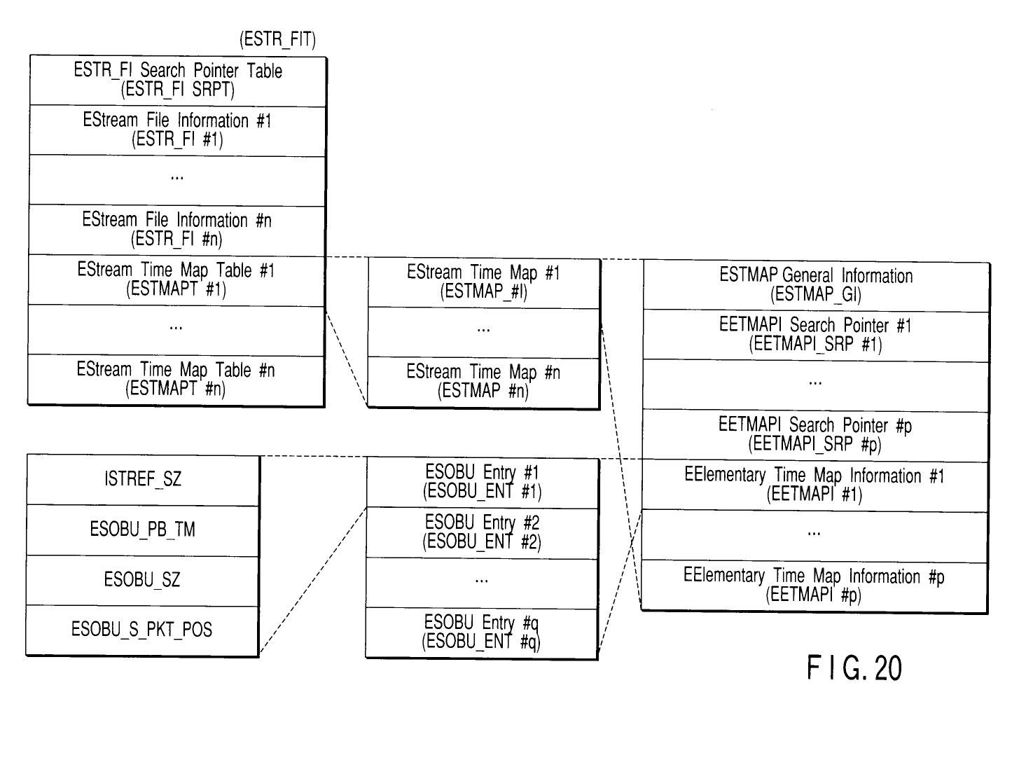

When the transfer rate is low, it is conceivable that one GOP cannot be set within a second (since internal encoding is done in VR, GOP can be set freely. However, since encoding is done at a broadcasting station in digital broadcasting, it may not be clear what data arrives). In that case, ESOBU is delimited at intervals of one second. To indicate that there is no reference picture in the delimited ESOBUs, 1STREFSE=0 is set. In this case, ESOBU that cannot be used in random access is created. Therefore, ESOBU including the head of a random-accessible picture is referred to as an entry ESOBU (ESOBU_ENT) in distinction from the inaccessible one. The information field of 1STREF_SZ is provided in ESOBU_ENT (described later with reference to FIG. 20) in a stream time map (ESTMAP) included in a stream file information table (ESTR_FIT).

A case where the transfer rate is high and I pictures are frequently sent can be considered. In this case, ESOBU is frequently delimited and therefore the amount of ESOBU management information increases, which can result in an enlargement in the total amount of management information. To avoid this problem, it is desirable that ESOBU (excluding the one in the last ESOB) should be delimited at specific time intervals (e.g., of 1 second on a picture basis) determined by the total recording time or at one or more GOPs.

Here, management information will be explained with reference to FIGS. 3 to 6. FIG. 3 is a diagram to help explain a file structure according to the embodiment. In this example, the directory for EVOB and that for ESOB are managed in a hierarchical directory. This makes it easy to manage each object. Even when data is converted into HD DVD-VIDEO, it is possible to deal with only the HDVR_VOB directory.

In directory DVD_HDVR, HR_MANGER.IFO (VMG file) is placed. In directory HDVR_VOB, an EVOB OBJECT file HR_MOVIE.VRO and TMA files for the individual EVOBs HR_Vmmmm.MAP (mmmm is the same number as VOB_INDEX: 1 to 1998) are placed. In HDVR_SOB, an ESOB OBJECT file HR_STRnn.SRO, an ESOB (AT_SOB) management file HR_SFInn.SFI (when nn=00, TYPE_B, when nn=01 to 0xff, TYPE_A), a TMAP file for each ESOB (AT_SOB) Snn_mmmm.SMP (when nn=00, TYPE_B, when nn=01 to 0xff, TYPE_A, where mmmm is the same number as ESOB (AT_SOB)_INDEX: 1 to 1998) are placed. In this case, a common VTMAP structure can be considered to increase the compatibility with HD_DVD-VIDEO.

In a method of broadcasting (delivering) compressed moving images in cable broadcasting, such as digital TV broadcasting or the Internet, the MPEG-TS, a common basic format, is divided into a packet management data part and a payload. In the payload, data to be reproduced is included in a scrambled state. According to ARIB, none of PAT (Program Association Table), PMT (Program Map Table), and SI (Service Information) are scrambled. Using PMT and SI (SDT: Service Description Table, EIT: Event Information Table, BAT: Bouquet Association Table), various pieces of management information are created.

Objects to be reproduced include MPEG video data, MPEG audio data, and data broadcasting data, and further information (such as program information) necessary for reproduction, including PAT, PMT, and SI, although not directly related to objects to be reproduced. PAT includes PID (Packet Identification) of PMT for each program. Further in PMT, PID of video data and audio data is recorded.

For example, a normal reproducing procedure in an STB (Set Top Box) is as follows. When the user decides on a program according to an electronic program table (EPG information) or the like, PAT is read in at the start time of the target program, PID of PMT belonging to the desired program is determined on the basis of the read-in data, the target PMT is read according to the PID, and PIDs of the included video and audio packets to be reproduced are determined. Then, video and audio attributes are read on the basis of PMT and/or SI, the read attributes are set in the video decoder and audio decoder, and the video and audio data are segmented according to PID, thereby performing reproduction. Since PAT, PMT, SI, and others are used also in switching between channels (so as to cause an image to appear immediately after channels are changed), they are received at intervals of several hundreds of milliseconds.

In mobile broadcasting, one-segment broadcasting is now in operation. In this type of broadcasting, there is no PAT and there are only NIT (Network Information Table) and PMT. PMT is determined in advance by a service number written in NIT. According to the service number, PMT is determined.

When a digital broadcast is transmitted from the tuner to a recording unit, such as a streamer, and is recorded there, only the object data for the target program is selected and recorded. This format is referred to as partial TS. In this case, PAT and/or PMT are edited again according to the target program. SIT (Selection Information Table) and DIT (Discontinuity Information Table) are further added to the resulting tables. SIT is created on the basis of EIT (Event Information Table) or the like in the broadcast and is inserted with the same timing as EIT. DIT is inserted into a place where bit streams are discontinuous. DIT is inserted in the form of a set of 2 TS packets. This makes it possible to determine whether the content is discontinuous.

In recent years, DVD recorders have come into wide use and have been taking the place of VTRs in demand. One of the characteristic functions of the DVD recorder is a chapter (entry point) automatic generation function. This function, which is included in most DVD recorders, is to place an entry point at regular intervals of time (automatic chapter division) and be able to skip reproduction.

Moreover, digital broadcasting has become widespread and will eventually replace analog broadcasting. In this connection, according to an embodiment of the invention, there is provided a method of placing entry points compatible with digital broadcasting when chapters are created automatically in digital broadcasting as in analog broadcasting. There is further provided a method of changing a reproducing process (or an output method), while checking the cell type C_TY (CELL_TYPE) for each cell, a unit in playing back a DVD.

When a digital broadcast program is recorded into a high-speed disk medium, such as HDD or HD DVD-RAM, it is advantageous to record broadcast stream data directly as digital data. For this reason, the HD DVD-VR standard has been determined. In this standard, ESR (extend stream recording), a format that enables a stream to be recorded as it is differently from the conventional VR (video recording) format, is merged with VR. This makes the HD DVD-VR standard compatible with digital broadcasting without impairing VR resources.

Incidentally, digital broadcasting differs in broadcast system from one country to another. For example, in Europe, DVB (Digital Video Broadcasting) is in operation. In the United States, ATSC (Advanced Television Systems Committee) is in operation. In Japan, ARIB (Association of Radio Industries and Business) is in operation.

In DVB, video is in MPEG2, the resolutions are 1152*1440i, 1080*1920 (i, p), 1035*1920, 720*1280, (576, 480)*(720, 544, 480, 352), (288, 240)*352, the frame frequencies are 30 Hz and 25 Hz, audio is in MPEG-1 audio and MPEG-2 Audio, and the sampling frequencies are 32 kHz, 44.1 kHz, and 48 kHz.

In ATSC, video is in MPEG2, the resolutions are 1080*1920 (i, p), 720*1280p, 480*704 (i, p), and 480*640(i, p), the frame frequencies are 23.976 Hz, 24 Hz, 29.97 Hz, 30 Hz, 59.94 Hz, and 60 Hz, audio is in MPEG-1 Audio Layer 1 & 2 (Direct TV) and AC3 Layer 1 & 2 (Primstar), and the sampling frequencies are 48 kHz, 44.1 kHz, and 32 kHz.

In ARIB, video is in MPEG2, the resolutions are 1080i, 720p, 480i, and 480p, the frame frequencies are 29.97 Hz and 59.94 Hz, audio is in AAC (MPEG-2 Advanced Audio Coding), and the sampling frequencies are 48 kHz, 44.1 kHz, 32 kHz, 24 kHz, 22.05 kHz, 16 kHz.

As described above, digital broadcasting differs in system from one country to another. Moreover, it may differ in system from one station to another. Therefore, in a recorder, an object has to be recorded in the form of one or more files according to the system used.

Because of this, a file added to the existing VR file configuration in the embodiment is so configured that a plurality of “nn” can exist under the file names HR_SFInn.SFI and HR_SFInn.BUP as shown in FIG. 3. One or more files configured this way are added for each broadcast system.

For example, “nn”=00 can be used when the broadcast system is unknown or when the recorder is incompatible with the broadcast system. In this case, a stream whose broadcast system is unknown or a stream in a broadcast system with which the recorder is incompatible can be stored as a type B stream (ESPB_STRB). Therefore, a plurality of pieces of ESTR_FI exist to change digital broadcasting management information ESTR_FI on a station basis (or a broadcast system basis).

Here, AT_SOBU (Arrival Time based SOBU) is defined as a basic unit of a type B stream (for example, a stream object including packets arriving in a second: ESPB_STRB). In a case where management information is constructed on the basis of PATS when a stream cannot be analyzed, AT_SOBU is delimited at time intervals shown in AT_SOBU_TM (Time Range of Arrival Time based SOBU). AT_SOBU_TM may be specified in two ways, in seconds and by the count of 27 MHz. Although AT_SOBU_TM is not shown, it is written as a part of type B time map information in ESOBI of FIG. 4.

FIG. 4 is a diagram to help explain the way ESTR_FIT, EX_ORG_PGCI, and EX_UDPGCIT (playlist information) included in HDVR_MG (VGM file) are configured. ESTR_FIT is composed of general information ESTR_FI_GI, one or more search pointers ESOBI_SRP#1 to #n, and one or more ESOBI#1 to #n. ESTR_FI_GI is composed of identifier SFI_ID, end address ESTR_FI_EA, version information VERN, last modification time ESTR_FI_LAST_MOD_TM, packet type PKT_TY, packet size PKT_SZ, packet group size PKT_GRP_SZ, the number of packets in a packet group PKT_Ns, and the number of search pointers ESOBI_SRP_Ns.

SFI_ID is represented as “HR_SFInn” and becomes “HR_SFI00” in the type B recording mode. In the type A recording mode, “nn” in “HR_SFInn” takes any one of 01 to FF. That is, whether the recorded ESOB is type A or type B can be determined, depending on whether “nn” in “HR_SFInn” is “00.”

Furthermore, there are two types of reproducing information EX_PGCI. Like the normal VR format, ORG_EX_PGCI (original program chain information) is created automatically by a recorder. UD_EX_PGCIT is created in the order of reproduction the user adds freely and is called a playlist. These two PGCIs have a common format at EX_PGC level. Its EX_PGC format is shown in FIGS. 4 to 6.

FIG. 5 is a diagram to help explain a concrete example of cell information EX_CI included in EX_PGC information. In EX_CI, the types of ESOB and AT_SOB are added to cell type C_TY. Further in EX_CI, search pointer number ESOBI_SRPN, cell start time C_S_PTM/C_S_PATS, cell end time C_E_PTM/C_E_PATS, default video ESOB_ESI number of the relevant cell C_DEF_V_SOB_ESIN, and others can be written. The cell start time and cell end time can be expressed by either the reproducing time (on the basis of PTM) or the packet arrival time (on the basis of PATS).

If the time is set as the reproducing time=the actual time in reproduction, the same access method as in the existing DVD video recorder (DVD-VR) can be used, although a stream recording method of recording the received directly has been used. This enables the user to specify a recording place using the reproducing time, thereby reflecting the user's desire completely. This method, however, can be used only when the contents of the stream can be analyzed sufficiently. When the contents of the stream are not known sufficiently, the recording place has to be specified in units of the transfer time of a stream packet (MPEG-TS packets in digital broadcast recording).

When the recording place is specified using the reproducing time in a state where the contents of the recorded stream are not known sufficiently, reproducing is not necessarily from the head of an I picture. Therefore, if a frame reproduced first is not the frame of an I picture, decoding is started from the preceding I picture. When decoding has been done up to the target frame, the display of reproduced image is started. By doing this, it is possible to show the user as if reproduction were started from the frame whose time was specified by the user.

As for ID referred to in a reproducing process or the like, the following methods can be considered: a method of setting PID of a stream representing the streams to be reproduced, a method of setting ID of a component group in the case of multiview TV or the like, and a method of specifying by ESI number (e.g., FIG. 5). (As for PID setting, the following methods can be considered: a method of writing in 13 bits of actual data, a method of writing the order in PMT, and a method of writing the value of a component tag). Moreover, a method of entering GRP numbers (GRP_SRP number) to be referred to and switching them can be considered.

A unique ID number (PG_INDEX corresponding to EX_PGI#p of FIG. 5, not shown) is attached to a program, thereby making it possible to specify a program or a cell by an unchanged number even if a middle part of the program or a middle cell is eliminated. In cell information (EX_CI) of FIG. 5, file number (ESTR_FIN) of a stream to be reproduced and search pointer number ESOBI_SRPN of the corresponding ESOBI are set. Moreover, in EX_CI, cell entry point information C_EPI (Entry Point Information) corresponding to a chapter is provided.

Although not shown, date and time information as to when the relevant program was updated (PG_LAST_MOD_TM) is stored in each piece of program information (EX_PGI_#1 to #p) included in EX_PGC information of FIG. 5. This makes it possible to know when the relevant program was edited. In each EX_PGI, there is a field for primary text information (PRM_TXTI) for description of program names and others. To store other text information, there is provided an item text (IT_TXT) area in EX_TXTDT_MG of FIG. 4. In the item text area, other information (including director's name and featured actor's name) is stored. The search pointer number of the stored IT_TXT is set in the EX_PGI for linking. The corresponding program number is set in IT_TXT data. The program number is an absolute number since, for example, the disk 100 of FIG. 1A started to be written into and is an unchanged index number (PG_INDEX) even if other programs are eliminated.

In EX_PGI, there is a resume information field (PR_RSM_MRKI) (existing in the search pointer of the playlist) as in the playlist, thereby making it possible to write a resume marker (a marker to indicate how much reproducing had been done at the time of interruption) for each program. Although not shown, in PG_RSM_MRKI, cell number CN, reproduction starting point MRK_PT, and date and time information MRK_TM as to when the marker was made are set as information for resuming reproduction. These are used as title resume. In MRK_PT, reproducing time PTM is written in a movie cell or a type A stream cell and packet arrival time PATS is written in a type B stream cell.

Furthermore, in EX_PGI, there is a program representative picture information field (PG_REP_PICTI). In PG_REP_PICTI, picture point PICT_PT, number CN of a cell in which a picture point is, and others are written as representative picture information for each program (a marker for an image displayed in the form of a thumbnail on a title menu or the like). In PICT_PT, the reproducing time PTM of a representative picture is written in a movie cell or a type A stream cell and the packet arrival time PATS of a representative image is written in a type B stream cell.

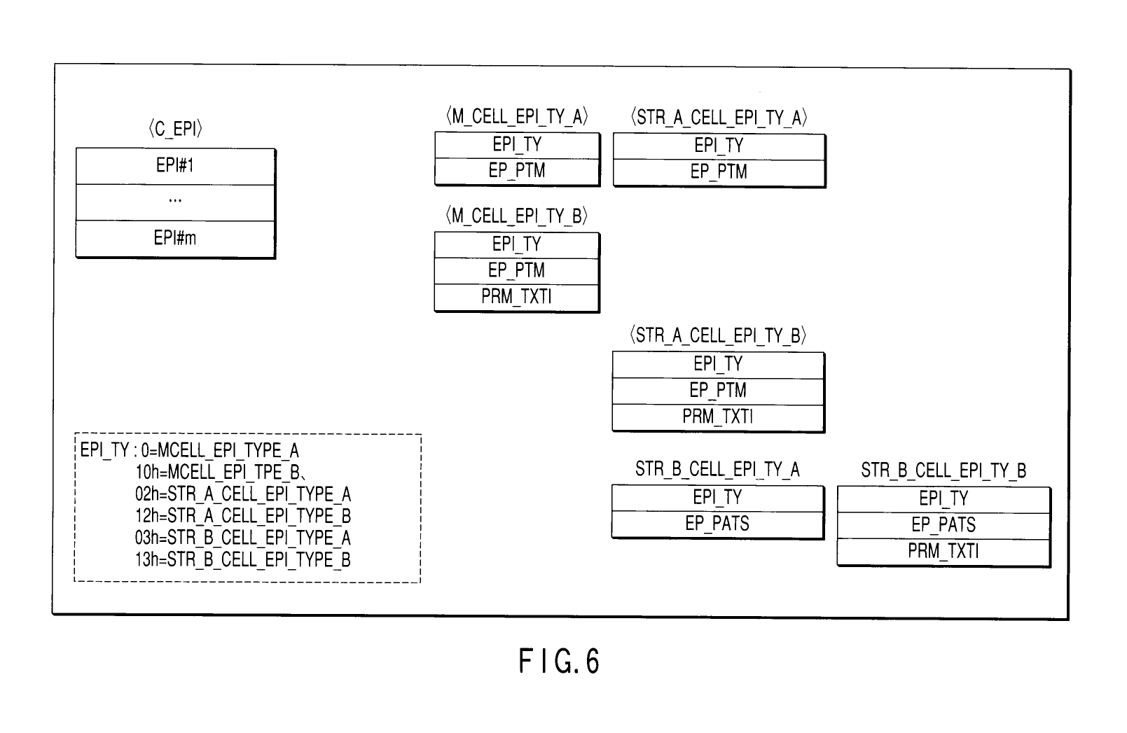

FIG. 6 is a diagram to help explain a concrete example of C_EPI. There are two types of C_EPI for each cell type, resulting in a total of six types. M_CELL_EPI_TY_A is composed of entry point information type (EPI_TY) and the reproducing time (EP_PTM) of a place to which an entry point is placed. M_CELL_EPI_TY_A is composed of not only EPI_TY and EP_PTM but also PRM_TXTI (primary text information).

STR_A_CELL_EPI_TY_A (for ESOB type A) is composed of entry point information type (EPI_TY) and the reproducing time (EP_PTM) at a place to which an entry point is placed. STR_A_CELL_EPI_TY_B is composed of not only EPI_TY and EP_PTM but also PRM_TXTI (text information).

STR_B_CELL_EPI_TY_A (for ESOB type B) is composed of entry point information type (EPI_TY) and the packet arrival time (EP_PATS) at a place to which an entry point is placed. STR_B_CELL_EPI_TY_B is composed of not only EPI_TY and EP_PATS but also PRM_TXTI (text information).

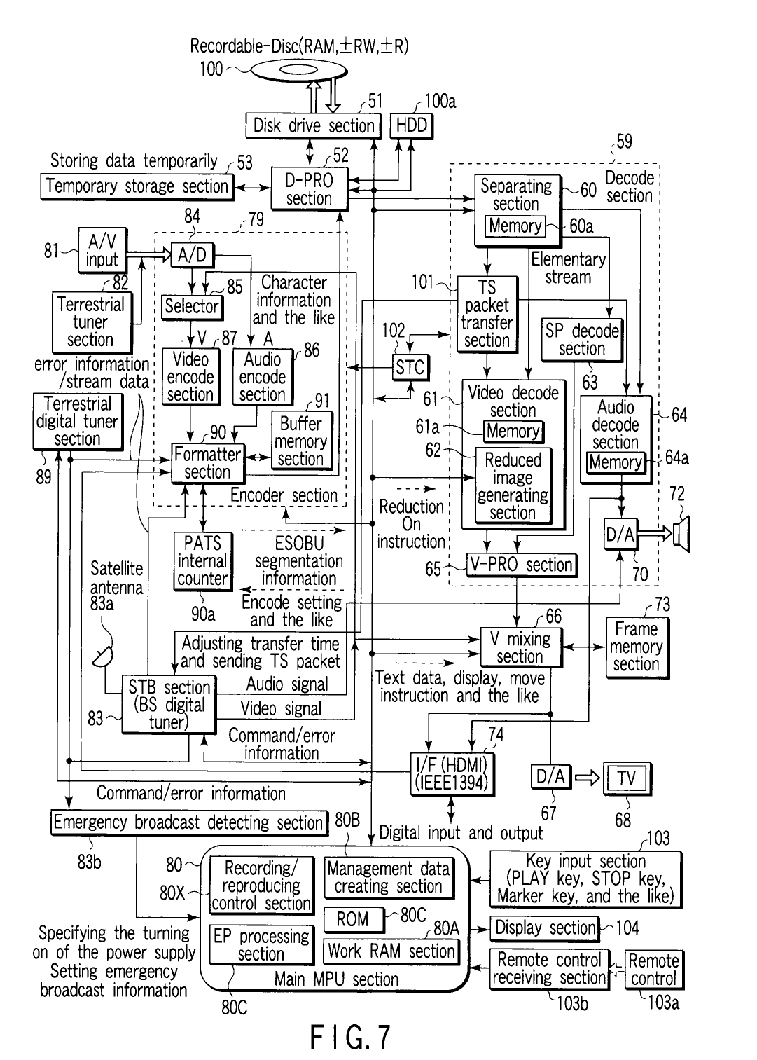

FIG. 7 is a block diagram showing an apparatus which records and reproduces AV information (such as digital TV broadcast programs) into and from an information recording medium (such as an optical disk or a hard disk) using the data structure of the embodiment. As shown in FIG. 7, the recording and reproducing apparatus comprises an MPU section 80, a display section 104, a decoder section 59, an encoder section 79, a TV tuner section 82, an STC section 102, a D-PRO section 52, a temporary storage section 53, a disk drive section 51, a key input section 103, a video mixing section 66, a frame memory section 73, a TV digital-to-analog conversion section 67, a terrestrial digital tuner section 89, an IEEE 1394 (and/or HDMI) interface section 74, an Ethernet (registered trademark) interface section (not shown), a remote control receiving section 104, an STB section (such as BS digital tuner) 83, an emergency broadcast detecting section 83b, and an HDD section 100a. In this configuration, the function of a streamer is added to the recording and reproducing DVD recorder.

The encoder section 79 is composed of an analog-to-digital section conversion 84, a video encode section 87, an audio encode section 86, a sub-picture encode section (not shown), a formatter section 90, and a buffer memory section 91. The decoder section 59 is composed of a separating section 60, a video decode section 61, a sub-picture decode section 63, an audio decode section 64, a TS packet transfer section 101, a V-PRO section 65, and an audio digital-to-analog conversion section 70. To the STB section 83, an antenna 83a for receiving digital broadcasting is connected. The STC section 102 is configured to count on the basis of 27 MHz.

The flow of the signal in recording is as follows. The TS packet data received at the STB section 83 (or terrestrial digital tuner 89) is organized into a packet group at the formatter section 90. The packet group is stored temporarily in the buffer memory section 91. When a specific number of packet groups have been accumulated, they are recorded onto the disk 100 and/or 100a. To the formatter section 90, a PATS internal counter 90a is connected. The arrival time of a TS packet is counted by the PATS counter 90a, which attaches the count to the head of each TS packet. The resulting TS packet is buffered in the buffer memory section 91. The counter 90a fine-adjusts the count interval for synchronization on the basis of PCR (or SCR) but does not load the value of PCR (or SCR) as the STC 102.

When a TS packet is received, grouping is done in units of 170 packets and a packet group header is created. In that case, only high two bytes in PATS of the begin Packet in Packet Group are put in the header (FIRST_PATS_EXT) and only low four bytes in the remaining PATS are stored together with the TS packet (in the PATS ahead of the TS packet). The analog signal input from the terrestrial tuner 82 or line input is digitized at the analog-to-digital conversion section 84. The digital signal is input to each encode section. Specifically, the video signal is input to the video encode section 87, the audio signal is input to the audio encode section 86, and character data, such as text broadcast, is input to the sub-picture encode section (not shown). For example, the video signal is MPEG-compressed. The audio signal is subjected to MPEG audio compression. The character data is subjected to run length compression.

The output from each encoder section (for VR) is packeted so as to contain 2048 bytes when the compressed data is packed. The resulting packet is input to the formatter section 90. The formatter section 90 packs each packet and multiplexes the resulting packs into program streams, which are sent to the D-PROM section 52.

The D-PRO section 52 creates an ECC block in units of 16 logical blocks and adds error correction data to the ECC block. The diver section 51 records the ECC block onto the disk 100 (or HDD 100a). When the drive section 51 is in a busy state because it is in a seek operation or in a track jump operation, the ECC block is stored in the temporary storage section 53 and waits for the drive section 51 to be ready. The formatter section 90 creates each piece of segment information during recording and sends the information (such as GOP head interrupt) periodically to the MPU section 80. The segment information includes the number of packs in EVOBU (ESOBU), the end address of a reference picture (I picture) from the head of EVOBU (ESOBU), and the reproducing time of EVOBU (ESOBU).

The flow of the signal in reproduction is as follows. The drive section 51 reads data from the disk 100 (or HDD 100a). The D-PRO section 52 makes an error correction and inputs the result to the decoder section 59. The MPU section 80 determines whether the input data is VR data or SR data (according to the cell type of FIG. 5) and sets the determined type in the decoder section 59. In the case of SR data, the MPU section 80 determines not only PID to be reproduced on the basis of the ESI number to be reproduced but also PID of each item (such as video or audio) to be reproduced on the basis of PMT and sets the results in the decoder section 59. In the decoder section 59, the separating section 60 sends each TS packet not only to the individual decode sections 61 to 64 but also the TS packet transfer section 101 on the basis of the PID and transmits the TS packet to the STB section 83 (and IEEE 1394 interface section 74) according to the arrival time. Each of the decode sections 61 to 64 does decoding. The digital-to-analog conversion section 62 converts the signal into an analog signal, which is displayed on the TV 68. In the case of VR data, the separating section 60 sends the data to the individual decode section 61 to 64 according to a fixed ID. Each of the decode sections 61 to 64 does decoding. The digital-to-analog conversion section 67 converts the signal into an analog signal, which is displayed on the TV 68.

In reproduction, the separating section 60 analyzes the pack data read from the disk 100 and/or 100a and, when a pack includes a TS packet, sends the pack to the TS packet transfer section 101. Thereafter, the pack is further sent to the individual decoders 61 to 64, which do reproducing. When transferring a packet to the STP section 83 (or when transferring a packet to an external device, such as a digital TV, through IEEE 1394 or the like), the TS packet transfer section 101 transfers only a TS packet at the same time interval as when the data arrived. The STB section 83 does decoding, thereby generating an AV signal. The AV signal is caused to pass through an in-streamer video encoder section and is displayed on the TV 68 or the like.

The characteristics of the medium 100 (100a) used in the apparatus of FIG. 7 are summarized as follows. The medium is composed of a management area 130 and a data area 131. In the data area, data is recorded in the form of a plurality of items of object data (ESOB). Each item of object data is composed of a set of data units (ESOBU). A data unit (ESOBU) is a packet group obtained by grouping a plurality of packets of digital broadcast signals conforming to MPEG-TS for each TS packet (see FIGS. 1F and 1G). The management area 130 has EX_PGC information (EX_PGCI) as information for managing the reproducing procedure. The EX PGC information includes cell information (EX_CI). The management area 130 further has information for managing object data (ESOB).

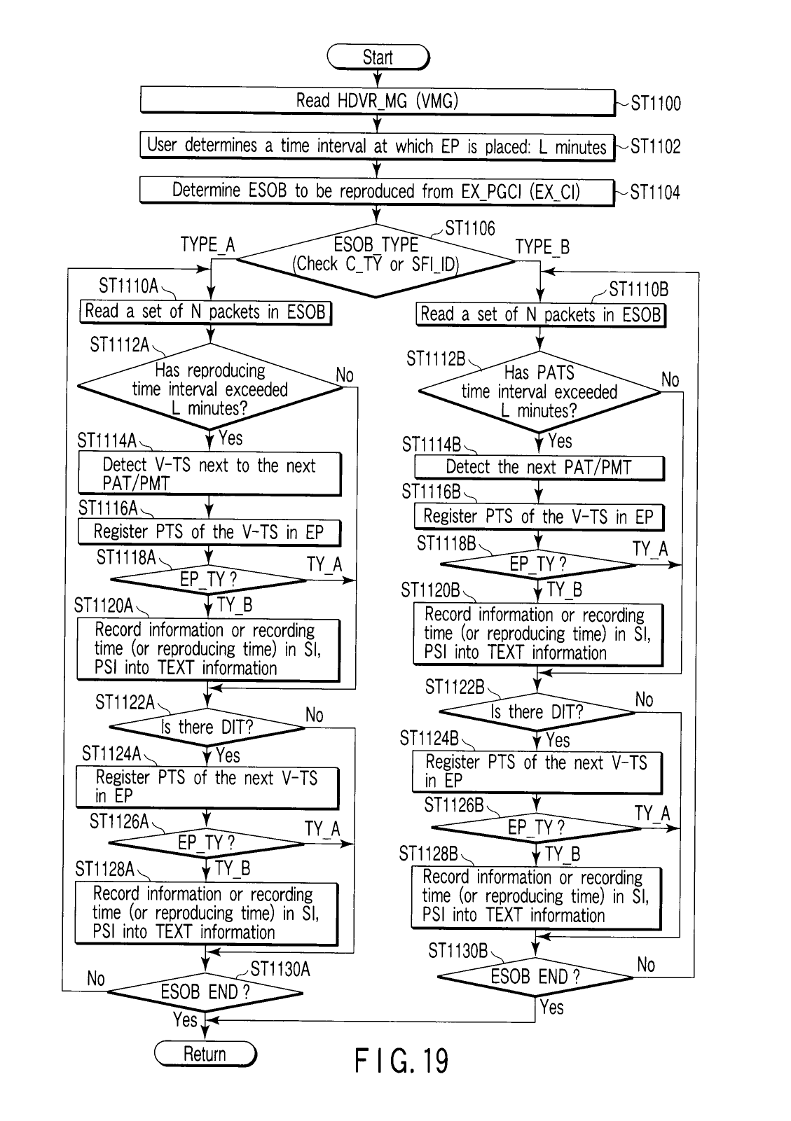

The apparatus of FIG. 7 can record not only video but also streams onto the medium 100 (100a) having the above-described data structure. In that case, to extract the program map table PMT or service information SI from the stream of the TS packet, the MPU section 80 is configured to have a service information extracting section (firmware constituting a part of a management data creating section 80B [not shown]). Moreover, the MPU section 80 is further configured to have an attribute information creating section (firmware constituting a part of the data management data creating section 80B [not shown]) for creating attribute information (such as PCR pack number or PCR LB number). The MPU section 80 further includes firmware for automatically generating entry points referring to FIG. 19 as an entry point processing section 80C.

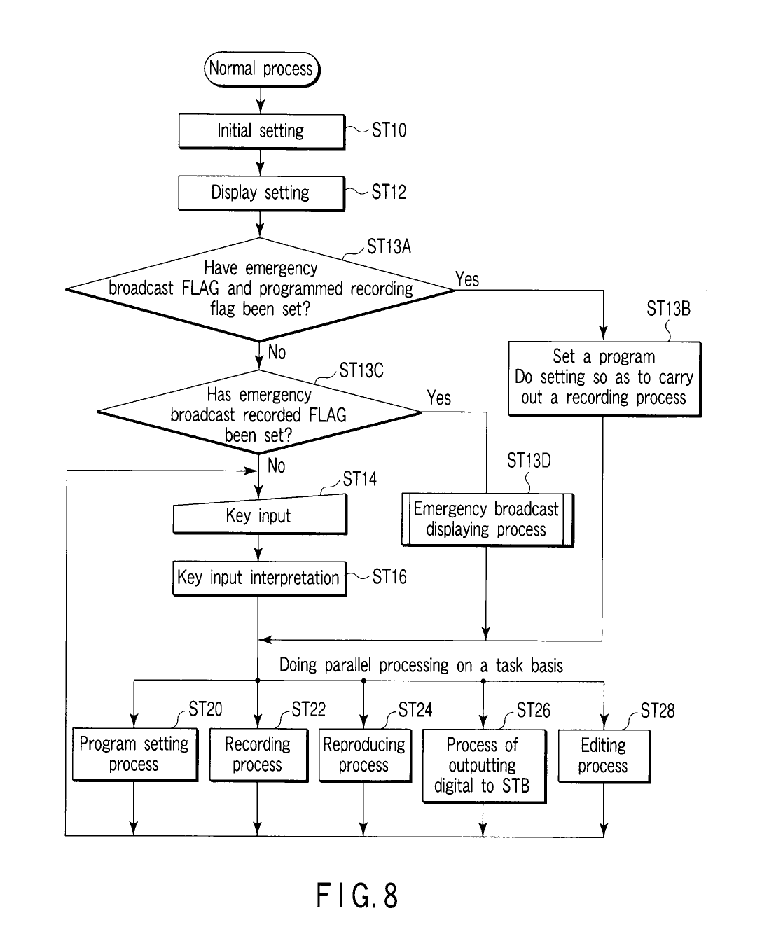

FIG. 8 is a flowchart to help explain an example of the operation of the entire apparatus of FIG. 7. The data processes include the following five: a recording process, a reproducing process, a data transfer process (such as the process of outputting digital data to STB), a program setting process, and an editing process. For example, the power supply of the apparatus of FIG. 7 is turned on, the MPU section 80 does initial setting (at the time of factory shipment or after the user does setting) (ST10) and then display setting (ST12). Then, the MPU section 80 checks whether an emergency broadcast flag and a programmed recoding flag have been set. If they have been set (YES in ST13A), the MPU section sets a programmed recording program and does setting so that the recording process may be carried out at a specific time (ST13B). If neither the emergency broadcast flag nor the programmed recoding flag has been set (NO in ST13A), the MPU section checks whether an emergency broadcast recorded flag has been set. If the emergency broadcast recorded flag has been set (YES in ST13C), the MPU section carries out the process of displaying an emergency broadcast (ST13D) even if the user does nothing. If the emergency broadcast recorded flag has not been set (NO in ST13C), the MPU section waits for the user to operate.

When the user performs a key input from the key input section 103 or remote control 103a in FIG. 7 (ST14), the MPU section 80 interprets the contents of the key input (ST16). According to a result of the input key interpretation, the following four data processes are executed suitably. Specifically, if the key input is, for example, a key operation for setting timer programmed recording, control goes into a program setting process (ST20). If the key input is a key operation for the start of recording, control goes into a recording process (ST22). If the key input is a key operation for the start of reproducing, control goes into a reproducing process (ST24). If the key input is a key operation for outputting digital data to STB, control goes into a digital outputting process (ST26). If the key input is a key operation for an editing process, control goes into an editing process (ST28).

The processes in ST20 to ST28 are processed in parallel on a task basis as needed. For example, during the reproducing process (ST24), the process of outputting digital data to STB (ST26) is executed in parallel. Alternatively, during the process of recording video without timer programmed recording (ST22), a new program setting process (ST20) may be carried out in parallel. Alternatively, making use of the characteristics of high-speed accessible disk recording, the reproducing process (ST24) and the digital outputting process (ST26) may be carried out in parallel during the recording process (ST22). While the HDD is being recorded into, a disk editing process (ST28) may be carried out.

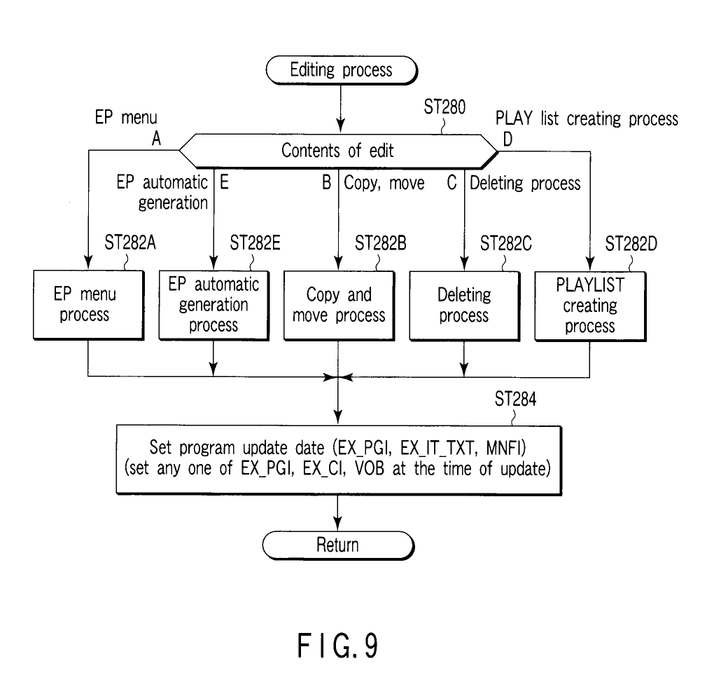

FIG. 9 is a flowchart to help explain an editing process (ST28). When control enters the editing process, control can go into any one of the five processes (A to E) (ST280). After an entry point menu process (ST282A), a copy/move process (ST282B), a delete process (ST282C), a playlist creating process (ST282D), or an entry point automatic generating process (ST282E) is completed, the date and time when the program was updated by the process are set in each piece of management information (including program information E_PGI, item text information EX_IT TXT, manufacturer information EX_MNFI) (ST284).

When any one of program information EX_PGI, cell information EX_CI, EVOB, and ESOB has been changed, the program update date and time may be set. When EVOBI and/or ESOBI has been changed, the editing time (EDIT_TIME) of EVOBI and/or ESOBI can be set in ESOB_EDIT_TIME or the like (not shown). Alternatively, the program update date and time may be set.

In the process in ST284, the maker ID of the unit which carried out any one of ST282A to ST282E may be set in the editor ID (LAST_MNF_ID) (not shown) in management information (VMG). When any one of PGI, CI, and ESOB (or EVOB) has been changed, the editor ID can be set (or updated) on the basis of ID information on the unit used at that time.

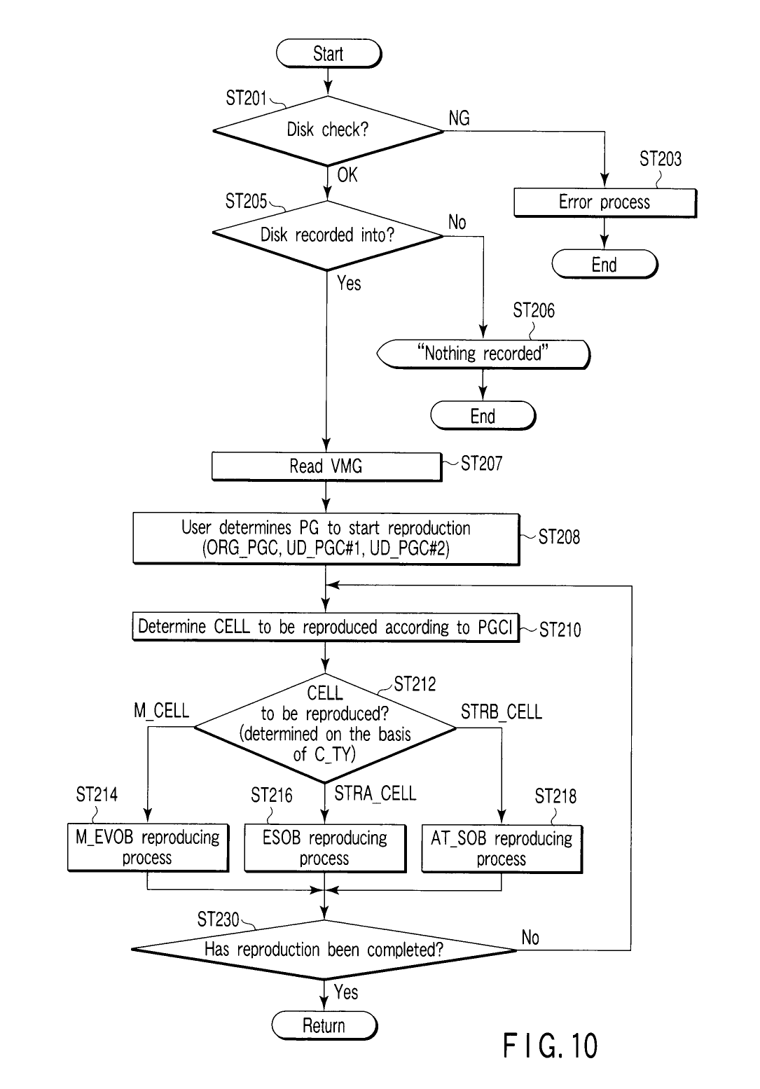

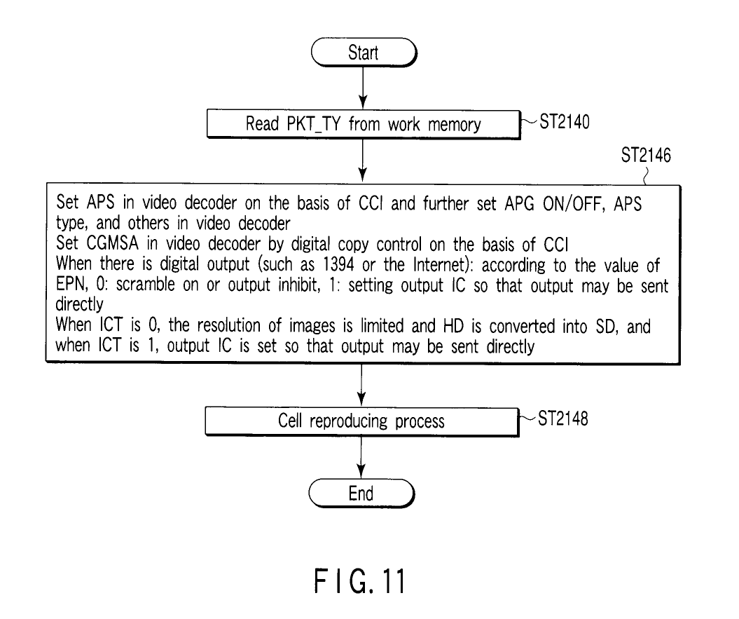

FIG. 10 is a flowchart to help explain an example of the entire reproducing operation. The data process in reproduction is, for example, as follows.

First, a check is made to see if the disk is a Recordable/Rewritable Disk (R, RW, RAM) (ST201). If the disk is not a Recordable/Rewritable Disk (NG in ST201), this information is returned and the process is terminated (ST203). If the disk is a Recordable/Rewritable Disk (OK in ST201), a check is made to see if the disk has been recorded into (ST205). If nothing has been recorded in the disk (NO in ST205), a dialog including a warning of nothing recorded (not shown) is displayed (ST206) and the process is terminated. If something has been recorded on the disk (YES in ST205), disk management information (HDVR¥MG/VMG file) is read (ST207).

A program and cells to be reproduced are determined on the basis of the read VMG file (the user is allowed to select the desired program from the menu display of the recorded titles/programs registered in the VMG file) (ST208). When reproduction in the order of recording has been selected, reproducing is done according to EX_ORG_PGCI. When reproducing is done for each program (edited by the user), a cell to be reproduced is determined according to EX_UD_PGCI (playlist) whose number corresponds to the program to be reproduced (ST210). This determination can be made according to the descriptive content of C_TY of FIG. 5.

When C_TY indicates a movie cell (ST212=M_CELL), control enters the process of reproducing M_EVOB (ST214). When C_TY indicates a type A stream cell (ST212=STRA_CELL), control enters the process of reproducing ESOB (ST216). When C_TY indicates a type B stream cell (ST212=STRB_CELL), control enters the process of reproducing AT_SOB (ST218). If the cell reproduction has not finished (NO in ST230), control returns to ST210. If the cell reproduction has finished (YES in ST230), control returns to another process.

In the embodiment, the types of EVOB, ESOB, and AT_SOB are determined on the basis of C_TY in reproduction and each reproducing process is carried out. In each reproducing process, since EVOB and ESOB are capable of video output (such as S terminal output, RCA output, or D terminal output), they are indispensable. In the case of AT_SOB, there is no decode function and only digital stream output (IEEE 1394 or HDMI output) is indispensable. Therefore, the output has to be changed according to an object to be reproduced, so that the output destination is changed on an object basis. In this case, the function of skipping reproduction on an entry point basis (or resuming the reproduction at the next entry point) by means of the SKIP key on the remote control (not shown) is indispensable.

FIG. 11 is a flowchart to help explain an EVOB reproducing operation. The MPU section 80 of FIG. 7 reads management information of FIG. 4 into a work RAM 80A before starting to reproduce the programs/titles recorded on the disk 100 and/or 100a. Thus, packet type PKT_TY written in ESTR_FI_GI of FIG. 4 is read from the work RAM 80A and the packet type is determined (ST2140). If the packet type indicates EVOB, control goes into a setting process in ST2146. Specifically, on the basis of copy control information CCI written in the packet group header 161 of FIG. 1H, APS is set in the video decoder 0=no APS, 1=APS type 1 added, 2=APS type 2 added, 3=APS type 3 added). Here, APS stands for Analog Protection System. On the basis of CCI, CGMSA is set in the video decoder (0=copy inhibit, 1=copy free). Moreover, if there is digital output, EPN is set (0=content protected, 1=content unprotected, in this case, setting is done on the output IC so that digital output may be sent directly). Furthermore, ICT is set (0=analog video output resolution limited, 1=high resolution output unlimited). After the above setting has been done, control enters the process of reproducing the cells in the corresponding EVOB (ST2148).

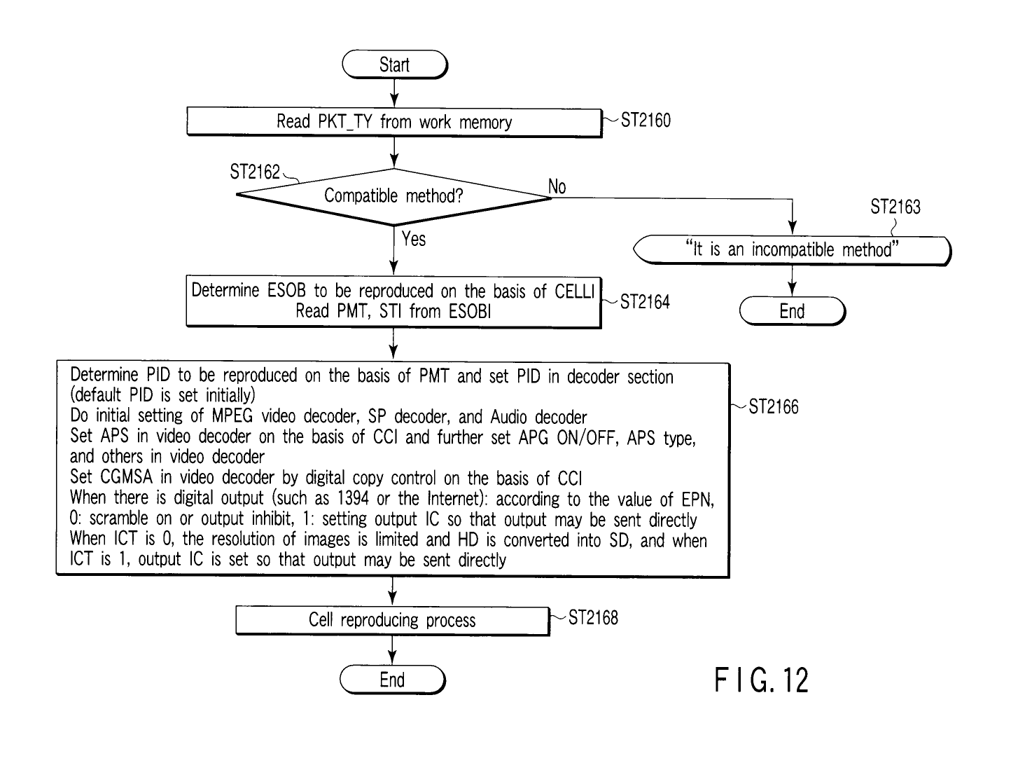

FIG. 12 is a flowchart to help explain an ESOB reproducing operation. The MPU section 80 reads PKT_TY from the work RAM 80A and determines the packet type (ST2160). If the packet type indicates ESOB, a check is made to see if the ESOB is a stream whose method is compatible with the apparatus of FIG. 7 (for example, whether the ESOB is ARIB). If the ESOB is a stream whose method is incompatible with the apparatus (NO in ST2162), a message to indicate incompatibility is displayed (ST2163) and the process is ended. If the ESOB is a stream whose method is compatible with the apparatus (YES in ST2162), ESOB to be reproduced is determined on the basis of cell information EX_CI of FIG. 5 and PMT and STI are read from the corresponding ESOBI (ST2164).

Thereafter, control enters a setting process in ST2166. Specifically, PID to be reproduced is determined on the basis of PMT and the determined PID is set in the decoder section (default PID is set initially). By doing this, initial setting is done on the MPEG video decoder, sub-picture decoder, and audio decoder. Thereafter, on the basis of CCI, APS is set in the video decoder (0=no APS, 1=APS type 1 added, 2=APS type 2 added, 3=APS type 3 added). On the basis of CCI, CGMSA is set in the video decoder (0=copy inhibit, 1=copy free). Moreover, if there is digital output, EPN is set (0=content protected, 1=content unprotected, in this case, setting is done on the output IC so that digital output may be sent directly). Furthermore, ICT is set (0=lowering the resolution from high-definition HD to standard SD, 1=outputting HD directly). After the above setting has been done, control enters the process of reproducing the cells in the corresponding ESOB (ST2168).

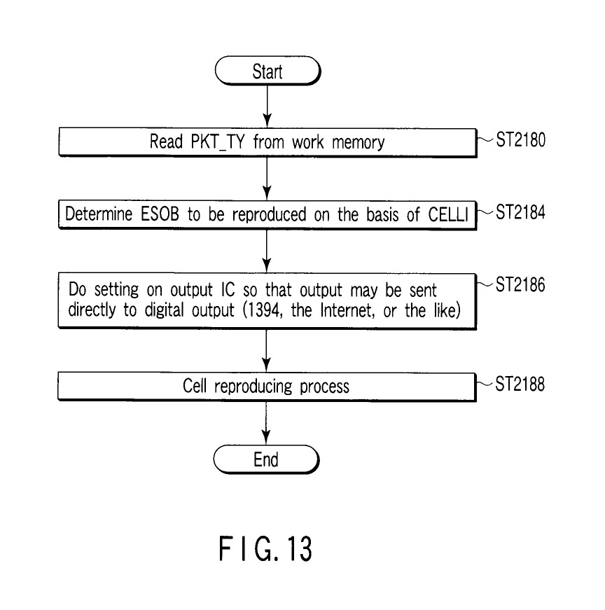

FIG. 13 is a flowchart to help explain an AT_SOB reproducing operation. The MPU section 80 reads PKT_TY from the work RAM 80A (ST2180) and determines a stream to be reproduced on the basis of EX_CI (ST2184). If the determined stream is AT_SOB, setting is done on the output IC so that the digital output may be sent directly (ST2186) and control goes into the process of reproducing the cells in the corresponding AT_SOB (ST2188).

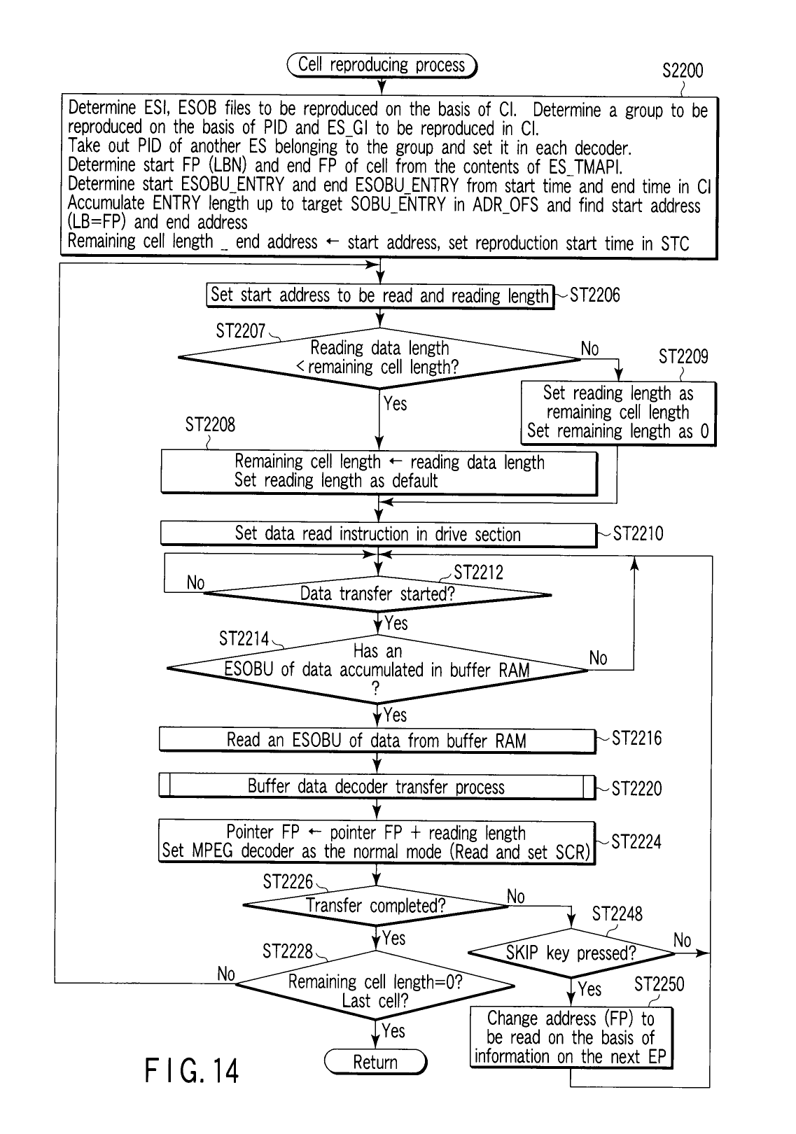

FIG. 14 is a flowchart to help explain an example of the process of reproducing a cell. The cell reproducing process is, for example, as follows.

First, on the basis of cell information EX_CI, ESI and an ESOB file to be reproduced are determined. On the basis of PID and ES_GI to be reproduced in EX_CI, a group to be reproduced is determined. PID of the other ES belonging to the group is taken out and set in each decoder. Then, from the contents of TMAPI, the start file pointer FP (logical block number LBN) and end final pointer FP (logical block number LBN) of the cell are determined. Moreover, from the start time and end time in EX CI, start ESOBU_ENT and end ESOBU_ENT are determined. Furthermore, in address offset ADR_OFS, the data length of entry up to the target ESOBU_ENT is accumulated, thereby finding a start address (LB=FP) and an end address. The remaining cell length is the value obtained by subtracting the start address from the end address and a reproduce start time is set in STC (ST2200).

Then, a read process is carried out. On the basis of a start file pointer, a read address and a read size are determined (ST2206). When the read unit size to be read is compared with the remaining cell length, if the remaining length is greater (YES in ST2207), the value obtained by subtracting the read unit size to be read from the remaining cell length is set in the remaining length (ST2208). If the remaining cell length is less (NO in st2207), the read length is set in the remaining length and the remaining length is set to 0 (ST2209). The read length is set to the read unit length and the read address, read length, and read instruction are set in the drive section (ST2210).

Once data transfer has started (YES in ST2212), the accumulation of an ESOBU of data in the buffer is awaited. When an ESOBU of data has accumulated (YES in ST2214), one ESOBU of data is read from the buffer (ST2216) and a buffer decoder transfer process is carried out (ST2220). Then, the read file pointer FP is incremented and the MPEG decoder is set to the normal mode (SCR is read and set) (ST2224). A check is made to see if the transfer has been completed. If the transfer has been completed (YES in ST2226), the remaining cell length is checked. If the remaining cell length is not “0,” that is, if the present cell is not the last cell (NO in ST2228), control returns to ST2206. If the remaining cell length is “0” (YES in ST2228), the process is ended.

If the transfer has not been completed (NO in ST2226), a check is made to see if the SKIP key has been pressed. If the SKIP key has been pressed (YES in ST2248), a SKIP process is carried out. That is, on the basis of information on the next entry point, the address to be read (file pointer) is changed (ST2250), and control is returned to the process in ST2212. If the SKIP key has not been pressed (NO in ST2248), control returns to the process in ST2212.

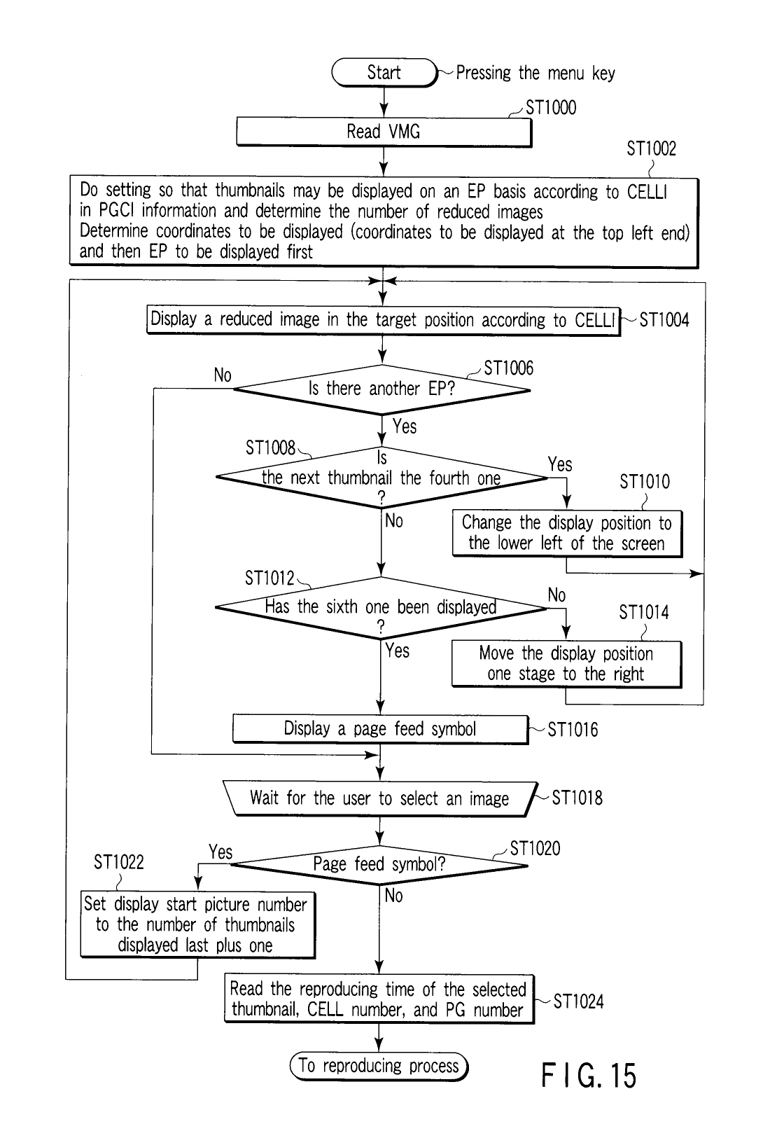

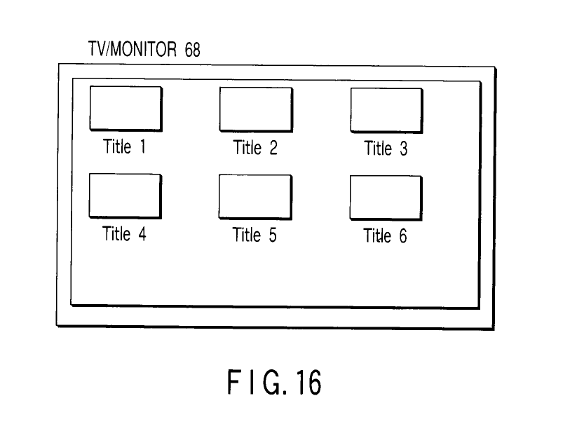

FIG. 15 is a flowchart to help explain an entry point menu displaying process. This process is carried out by the EP processing section 80C of the MPU section 80 of FIG. 7. FIG. 16 is a diagram to help explain an example of title menu display with entry points (an example of displaying six thumbnails corresponding to six entry points).

When control goes into the process of FIG. 15 as a result of the user pressing the menu key on the remote control (not shown) or the like, management information (VMG file) is read first and expanded in a work memory (ST1000). Of the management information expanded in the work memory, cell information (EX_CI in FIG. 5 and C_EPI in FIG. 6) is referred to and setting is done to display thumbnails (reduced images) on an entry point basis and the number of reduced images (six pictures in the example of FIG. 16) is determined. Thereafter, coordinates (the origin of coordinates is, for example, at the top left end of the screen) to be displayed on the monitor screen of FIG. 16 are determined and an entry point EP to be displayed first is determined (ST1002) (refer to thumbnail of “Title 1” in FIG. 16).

Then, according to the cell information, a thumbnail (reduced image) corresponding to the first EP is displayed in the target position on the screen (ST1004). If there is no other EP to be thumbnailed (NO in ST1006), the user is waited for to select a displayed specific thumbnail (ST1016). If there is another EP to be thumbnailed (YES in ST1006), a check is made to see in what number of the order of thumbnails the next one is. If the next thumbnail is the fourth one (YES in ST1008), the display position is changed to the lower left part of the screen as shown by the thumbnail of “Title 4” in FIG. 16 (ST1010) and the next thumbnail is displayed there (ST1004).

If there are still EPs to be thumbnailed (YES in ST1006) and the next thumbnail is neither the fourth one (NO in ST1008) nor the sixth one indicating the end of the display (NO in ST1012), the display position is moved one stage (equal to one thumbnail including the space between thumbnails) to the right. If the sixth thumbnail indicating the end of the display has been reached (YES in ST1012), a page feed symbol on a menu display is displayed (when there are the seventh and later EPs) (ST1016).

After the process of thumbnailing all of the EPs has been completed by the above processed, the user is waited for to select any one of the thumbnails (reduced images clipped out of the video image near the EP) or a page feed symbol (ST1018). If a page feed symbol is selected (YES in ST1020), the thumbnail display start picture number is set to the number of thumbnails displayed last plus one (ST1022) and a thumbnail of a newly set picture number is displayed at the top left of the next page (ST1004). If a specific thumbnail is selected (NO in ST1020), the reproducing time of the stream data corresponding to the selected thumbnail, the cell number, the program number, and others are read from the management information expanded in the work memory (ST1024) and control proceeds to a reproducing process.

By the process of FIG. 15, thumbnails are displayed in menu form on an entry point basis as shown in FIG. 16, which makes it possible to jump directly to the target entry point and do reproducing. In the case of an ESOB stream, the method of placing an entry point EP has two types, type A and type B. To start to reproduce moving images rapidly at the time of channel changing, PAT/PMT is inserted at intervals of 0.5 second (in the case of one-segment broadcasting, at intervals of 2 to 5 seconds). If reproduction is started at the PAT/PMT insertion point at the time of random access, there is a strong possibility that a reference picture will be taken out immediately. Therefore, it is natural that EP should be placed at the insertion point of PAT/PMT (in the case of one-segment broadcasting, of only PMT with no PAT). Since the place where DIT exists is a place where a stream was newly started, it is natural that EP should be placed there. A concrete example of placing an EP this way will be explained below.

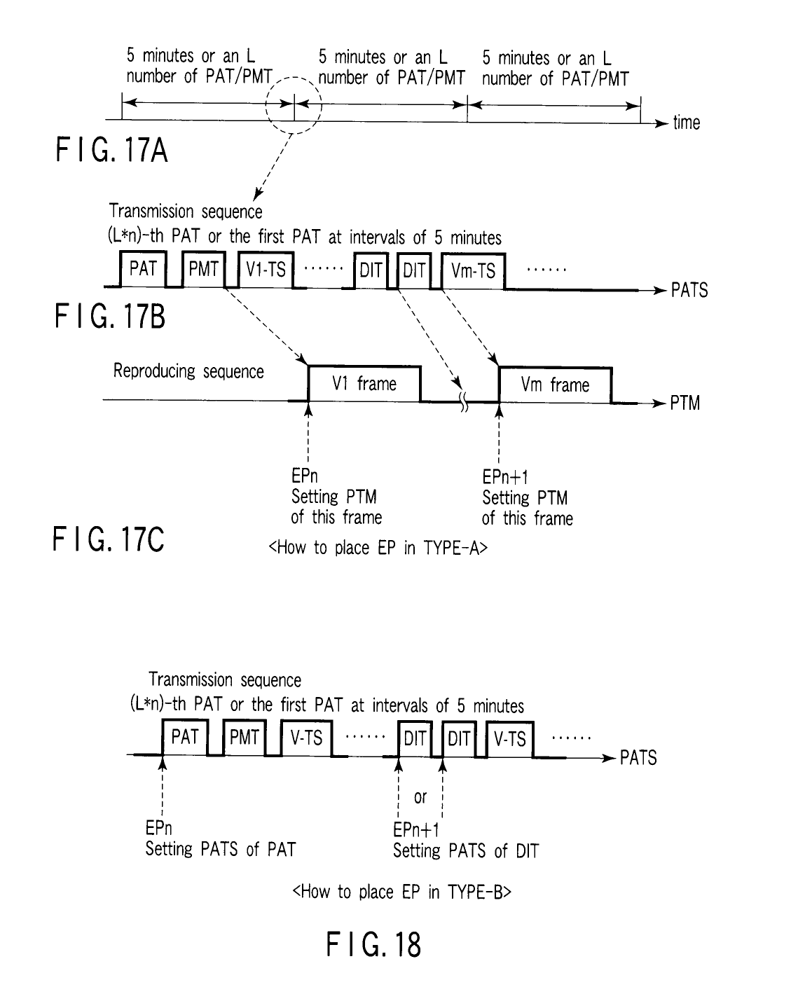

FIGS. 17A, 17B, and 17C are diagrams to help explain a method of placing entry points (in the case of type A). Since the reproducing time is used as a reference axis, it is necessary to set the value of PTS in EP. Therefore, PAT/PMT is found at the places corresponding to the intervals of the reproducing time (e.g., the intervals of five minutes) at which EP is placed. PTS of the video pack behind the PAT/PMT is set in EP (PTS or the like cannot be placed because neither PAT nor PMT is reproduced data). In DIT, PTS of the video pack behind two DITs is set in EP.

FIG. 18 is a diagram to help explain another method of placing entry points (in the case of type B). Since the arrival time is used as a reference axis, it is necessary to set the value of ATS in EP. Therefore, PAT/PMT is found at the places corresponding to the intervals of the arrival time (e.g., the intervals of five minutes) at which EP is placed. Its ATS is set in EP. Since there are two DITs, it is conceivable that ATS of the first or second DIT is set in EP.

FIG. 19 is a flowchart to help explain an entry point automatic generating process. This process is carried out by the EP processing section 80C of the MPU section 80 of FIG. 7. Hereinafter, an actual EP generating operation will be explained. First, management information (VMG file) is read and developed in a work memory (ST1100). The user specifies intervals at which an entry point EP is generated (ST1102). On the basis of EX_PGCI, EX_CI in which EP is placed is determined and ESOB registered there is read (ST1104).

On the basis of C_TY or SFI_ID, the type of ESOB is determined (ST1106). In the case of type A, control proceeds to ST1110A to generate EP on the basis of the PTM. In the case of type B, control proceeds to ST1110B to generate EP on the basis of the PATS.

In the case of type A, ESOB is read in units of a specific amount (ST1110A). A check is made to see if the reproducing interval has exceeded the user specified time (L minutes). If it hasn't exceeded the specified time (NO in ST1112A), control proceeds to ST1122A. If the reproducing interval has exceeded the user specified time (L minutes) (YES in ST1112A), PAT/PMT closest to the position of the reproducing interval is found and the video data TS packet behind the found PAT/PMT is detected (ST1114A). The reproducing time of the video packet is registered in the EP (ST1116A). If the type of EP is TY_B (ST1118A), SI and information in PSI (or reproducing time or recording time) are stored as text information (ST1120A).

A check is made to see if there is DIT in the read-in data. If there is no DIT (NO in ST112A), control goes to ST1130A. PAT/PMT closest to the position of the reproducing interval is found and the video data TS packet behind the found PAT/PMT is detected. The reproducing time of the video packet is registered in the EP (ST1124A). If the type of EP is TY_B (ST1126A), SI and information in PSI (or reproducing time or recording time) are stored as text information (ST1128A). A check is made to see if ESOB has ended. If ESOB has not ended (NO in ST1130A), control returns to ST1110A. If ESOB has ended (YES in ST1130A), the process of FIG. 19 is terminated.

In the case of type B, ESOB is read in units of a specific amount (ST1110B). A check is made to see if the arrival time interval has exceeded the user specified time (L minutes). If it hasn't exceeded the specified time (NO in ST1112B), control proceeds to ST1122B. If the arrival time interval has passed the user specified time (L minutes) (YES in ST1112B), PAT/PMT closest to the position of the arrival time interval is found and the video data TS packet behind the found PAT/PMT is detected (ST1114B). The arrival time of the video packet is registered in the EP (ST1116B). If the type of EP is TY_B (ST1118B), SI and information in PSI (or reproducing time or recording time) are stored as text information (ST11120B).

A check is made to see if there is DIT in the read-in data. If there is no DIT (NO in ST1112B), control goes to ST1130B. PAT/PMT closest to the position of the arrival time interval is found and the video data TS packet behind the found PAT/PMT is detected. The arrival time of the video packet is registered in the EP (ST1124B). If the type of EP is TY_B (ST1126B), SI and information in PSI (or reproducing time or recording time) are stored as text information (ST11128B). A check is made to see if ESOB has ended. If ESOB has not ended (NO in ST1130B), control returns to ST1110B. If ESOB has ended (YES in ST1130B), the process of FIG. 19 is terminated. As a result of this, EP can be generated in a place suitable for TS.

FIG. 20 is a diagram to help explain the way stream file information (ESTR_FIT) is configured. ESTR_FIT is composed of an ESTR _FI search pointer table ESTR_FI_SRPT, one or more pieces of stream file information ESTR_FI #1 to #n, and one or more stream time map tables ESTMAPT #1 to #n. Each ESTMAPT is composed of one or more stream time maps ESTMAP #1 to #n. Each ESTMAP is composed of stream time map general information ESTMAP_GI, one or more elementary time map information search pointers EETMAPI_SRP #1 to #n, and one or more pieces of elementary time map information EETMAPI #1 to #n. Each piece of EETMAPI is composed of one or more stream object unit entries ESOBU_ENT #1 to #n. Each ESOBU_ENT is composed of 1STREF_SZ in which the size of the first reference picture of the relevant ESOBU (in the case of MPEG-TS, I picture) is written, ESOBU_PB_TM in which the reproducing time of the ESOBU is written, ESOBU_SZ in which the size of the ESOBU is written, and ESOBU_S_PKT_POS in which the position of the begin packet of the ESOBU is written.

### Effect of the Embodiment

For the recording content of a digital broadcast, entry points can be generated automatically as in a conventional DVD-VR recorder. At that time, entry points can be placed in a suitable manner for the type of streams (type A or type B of ESOB).

### Summarization

1. Whether the time interval of entry point registration is set as PTM or PATS is determined, depending on whether the type is type A or type B. Specifically, in a DVD recording and reproducing apparatus conforming to the HD DVD-VR standard, when an entry point (EP) is generated automatically, the type of content created (type A/type B of ESOB) is changed according to management information and therefore whether to do processing on the basis of the reproducing time or the arrival time is determined.

If processing is done on the basis of the reproducing time, the reproducing time of the first video packet behind PAT/PMT closest to the target reproducing time is registered in EP (see FIGS. 17A, 17B, and 17C).

If processing is done on the basis of the arrival time, the arrival time of PAT/PMT closest to the target arrival time is registered in EP (see FIG. 18).

2. When DIT (Discontinuity Information Table) has been detected, an entry point is registered.

3. When the type of ESOB is type A, it is determined whether the type of EPI is type A or type B. If EPI is of type B, text information is recorded in PRM_TXTI.

4. When the type of ESOB is type A, it is determined whether the type of EPI is type A or type B. If EPI is of type B, text information is recorded in PRM_TXTI.

### Example of Correspondence Between the Embodiments and the Invention

(1) Using an information storage medium (100 of FIG. 1A or HDD 100a of FIG. 7) including a stream object recording area (133 of FIG. 1D) in which at least one of a type A stream object (ESOB type A) to be recorded in a type A recording mode for management using a reproducing time and a type B stream object (ESOB type B) to be recorded in a type B recording mode for management using a packet arrival time is recorded using packets and a management information recording area (130 of FIG. 1D) in which management information (HDVR_MG of FIG. 4) for managing the recording contents (ESOB type A/ESOB type B) in the stream object recording area is recorded, entry points (EPn and the like in FIGS. 17C and 18) are registered in the recording contents of the stream object recording area (ESOB type A/ESOB type B).

The management information (HDVR_MG of FIG. 4) is composed of stream file information (ESTR_FIT of FIG. 4) and program chain information (EX_ORG_PGCI/EX_UD_PGCI of FIG. 4, EX PGC information of FIG. 5). The stream file information (ESTR_FIT) includes first identification data (SFI_ID of FIG. 4) for determining whether an object to be managed is in the type A recording mode or the type B recording mode, and/or the program chain information (EX_PGC information) includes second identification data (C_TY of FIG. 5) for determining whether a cell serving as a reproducing unit in the recording contents (ESOB type A/ESOB type B) in the stream object recording area is in the type A recording mode or the type B recording mode.

An entry point registering method (FIG. 19) according to an embodiment of the invention comprises reading the management information (HDVR_MG or VMG) from the information storage medium (ST1100), when the contents of the first identification data (SFI_ID) and/or second identification data (C_TY) included in the management information indicate the type A recording mode (ST1106=type A), registering entry points at a specific reproducing time (at intervals of L minutes) (ST1112A to ST1116A), and when the contents of the first identification data (SFI_ID) and/or second identification data (C_TY) included in the management information indicate the type B recording mode (ST1106=type B), registering entry points at a specific packet arrival time (at intervals of L minutes) (ST1112B to ST1116B).

(2) At least one of the type A stream object (ESOB type A) and the type B stream object (ESOB type B) includes discontinuity information (digital broadcast DI: Discontinuity Information Table) that specifies a change point at which recorded program arrangement information might be discontinuous. When the contents of the first identification data (SFI_ID) and/or second identification data (C_TY) included in the management information indicate the type A recording mode (ST1106=type A), if the discontinuity information (DIT) has been detected (ST112A=Y), entry points are registered at the specific reproducing time (at intervals of L minutes) (ST1112A to ST1116A). When the contents of the first identification data (SFI_ID) and/or second identification data (C_TY) included in the management information indicate the type B recording mode (ST1106=type B), if the discontinuity information (DIT) has been detected (ST1122B=Y), entry points are registered at the specific packet arrival time (at intervals of L minutes) (ST1112B to ST1116B).

(3) The management information includes entry point information (EPI of FIG. 6). When the contents of the first identification data (SFI_ID) and/or second identification data (C_TY) included in the management information indicate the type A recording mode (ST1106=type A), if the entry point has been registered (ST1112A to ST1116A or ST1122A to ST1124A), it is determined whether the entry point information corresponding to the registered entry point is of a type having a text information field (ST1118A or ST1126A). If the entry point information is of a type having a text information field (STR_A_CELL_EPI_TY_B of FIG. 6), text information and/or time information is written in the text information field (ST1120A or ST1128A).

(4) The management information includes entry point information (EPI of FIG. 6). When the contents of the first identification data (SFI_ID) and/or second identification data (C_TY) included in the management information indicate the type B recording mode (ST1106=type B), if the entry point has been registered (ST1112B to ST1116B or ST1122B to ST1124B), it is determined whether the entry point information corresponding to the registered entry point is of a type having a text information field (ST1118B or ST1126B). If the entry point information is of a type having a text information field (STR_B_CELL_EPI_TY_B of FIG. 6), text information and/or time information is written in the text information field (ST1120B or ST1128B).

(5) The recording contents (ESOB type A/ESOB type B) of the stream object recording area are configured to include information on a program association table (PAT) and a program map table (PMT) determined in MPEG. In the type A recording mode (FIGS. 17A, 17B, and 17C), the entry point is registered in the video packet following close behind the program association table (PAT) or the program map table (PMT) recorded into at intervals of a specific time (e.g., five minutes) (the reproducing time of the video packet is recorded in C_EPI). In the type B recording mode (FIG. 18), the entry point is registered in the program association table (PAT) or the program map table (PMT) recorded into at intervals of a specific time (e.g., five minutes) (the packet arrival time of the PAT is recorded in C_EPI).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium comprising:
a stream object recording area configured to record at least one of a type A stream object and a type B stream object using data packets, the type A stream object being recorded in a type A recording mode for management using a reproducing time, and the type B stream object being recorded in a type B recording mode for management using a packet arrival time, and
a management information recording area configured to record management information for managing recording contents of the stream object recording area, and registering one or more entry points for the recording contents of the stream object recording area, wherein
the management information comprises stream file information and program chain information,
the stream file information includes first identification data for determining whether an object to be managed is in the type A recording mode or the type B recording mode,
the program chain information includes second identification data for determining whether a cell serving as a reproducing unit in the recording contents of the stream object recording area is in the type A recording mode or the type B recording mode,
the one or more entry points is configured to be registered at a specific reproducing time when the first identification data or the second identification data indicates the type A recording mode, and
the one or more entry points is configured to be registered at a specific packet arrival time when the first identification data or the second identification data indicates the type B recording mode.

2. An entry point registering method using an information storage medium which comprises, the method comprising:
registering one or more entry points at a specific reproducing time when the first identification data or the second identification data indicates the type A recording mode, and/or
registering one or more entry points at a specific packet arrival time when the first identification data or the second identification data indicates the type B recording mode.

3. The method of claim 1, wherein the entry points are configured to be periodically registered with a predetermined time interval.

4. A reproducing method using an information storage medium which comprises, the method comprising:
reading the management information from the management information recording area, and reproducing the recording contents of the stream object recording area based on the read management information.
